(19) United States
(12) Patent Application Publication
(10) Pub. No.: US 2003/0028589 A1
(43) Pub. Date: Feb. 6, 2003

(54) System and method to transfer an application to a destination server module in a predetermined storage format

(76) Inventors: Ken D. Hittleman, San Jose, CA (US); Eliahu Albek, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/082,485

(22) Filed: Feb. 22, 2002

Related U.S. Application Data
(60) Provisional application No. 60/270,837, filed on Feb. 23, 2001.

(51) Int. Cl. G06F 15/16; G06F 7/00; G06F 17/30

(52) U.S. Cl. 709/203; 709/228; 707/10

(57) ABSTRACT

A system and method to transfer an application to a destination server module in a predetermined storage format are described. A property name associated with a path name for each application component of the application is retrieved from a property file containing multiple property names including the retrieved property name and multiple path names including the corresponding path name for each application component. The corresponding property name is then applied to each application component to store the application and the property name associated with each application component in the predetermined storage format.

### RELATED APPLICATIONS

The present application claims the benefit of U.S. Provisional Patent Application Serial No. 60/270,837, filed on Feb. 23, 2001 and entitled “SYSTEM AND METHOD FOR ACCESSING, ORGANIZING, PRESENTING, AND VIEWING DATA.”

### FIELD OF THE INVENTION

The present invention relates generally to data representation and, more particularly, to a system and method to transfer an application to a destination server module in a predetermined storage format.

### BACKGROUND

The movement toward development, deployment, and maintenance of Internet, and especially World Wide Web (Web), based applications, such as, for example, J2EE-compliant enterprise applications, represents one of the most significant recent trends in the corporate Information Technology (IT) environment. However, the deployment and maintenance of such applications require tools and technology that are complex and skill sets that are rare.

Typically, web applications have a different lifecycle than most other applications. Most applications are delivered when finished, but a web application continues to change, as new market requirements are understood. As a result, projects are fraught with certain risk, due to the myriad of moving pieces having no methodology to hold them together.

Under technological pressure and facing a lack of resources, IT organizations decide to outsource the development of web applications. However, as the applications evolve, such reliance on third parties for development and maintenance may slow down progress, as each new third party learns what the previous group has accomplished, thereby impeding the necessary quick response time.

Furthermore, in certain situations, the developed web applications need to be stored and transported to multiple computer configurations having different configuration parameters. A known method to transport such web applications involves the creation of a compressed file containing the web application and extraction of the application from the compressed file at the destination. However, the configuration information of certain components of the web application may be different than the configuration at destination and may potentially impede the installation of those components.

A solution to the above problem requires the saving of each component of the application in a compressed file storage format and extracting each component from the corresponding file at the destination. However, this method appears to be inefficient and time consuming in that it requires multiple compressed files to be created for the selected application.

What is needed is a single, integrated, development and runtime platform for web applications that streamlines the development, deployment, monitoring, and management of such applications, while improving productivity and quality, and, at the same time, significantly reducing associated costs. Also, what is needed is an efficient system and method to transfer a web application to a destination computer configuration in a predetermined storage format.

### SUMMARY

A system and method to transfer an application to a destination server module in a predetermined storage format are described. A property name associated with a path name for each application component of the application is retrieved from a property file containing multiple property names including the retrieved property name and multiple path names including the corresponding path name for each application component. The corresponding property name is then applied to each application component to store the application and the property name associated with each application component in the predetermined storage format.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a conventional network architecture.

FIG. 2 is a block diagram of one embodiment of the network including a system to transfer an application to a destination server module in a predetermined storage format.

FIG. 3 is a block diagram of a conventional computer system.

FIG. 4A is a block diagram of an application architecture.

FIG. 4B is a block diagram of one embodiment for a user interface module.

FIG. 5 is a block diagram of one embodiment for a server module within the system.

FIG. 6 is a flow diagram of one embodiment for a method to transfer an application to a destination server module in a predetermined storage format from the perspective of a source server module.

FIG. 7 is flow diagram of one embodiment for the method from the perspective of the destination server module.

### DETAILED DESCRIPTION

According to embodiments described herein, a system and method to transfer an application to a destination server module in a predetermined storage format are described. A property name associated with a path name for each application component of the application is retrieved from a property file containing multiple property names including the retrieved property name and multiple path names including the corresponding path name for each application component. The corresponding property name is then applied to each application component to store the application and the property name associated with each application component in the predetermined storage format.

In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

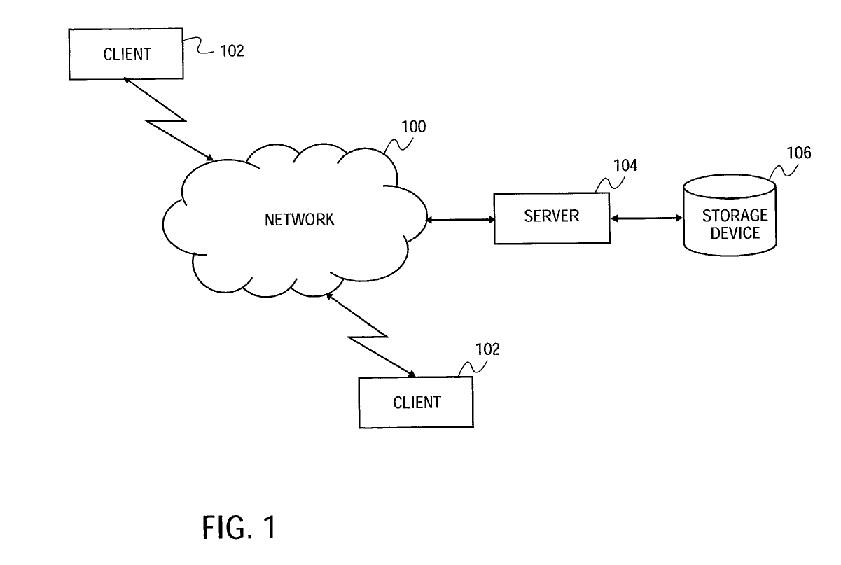

FIG. 1 is a block diagram of a conventional network architecture. Referring to FIG. 1, the block diagram illustrates the network environment in which the present invention operates. In this conventional network architecture, a server computer system 104 is coupled to a network 100, for example a wide-area network (WAN). Wide-area network 100 includes the Internet, specifically the World Wide Web, or other proprietary networks, such as America Online™, CompuServe™, Microsoft Network™, and/or Prodigy™, each of which are well known to those of ordinary skill in the art. Wide-area network 100 may also include conventional network backbones, long-haul telephone lines, Internet service providers, various levels of network routers, and other conventional means for routing data between computers. Using conventional network protocols, server 104 may communicate through wide-area network 100 to a plurality of client computer systems 102, possibly connected through wide-area network 100 in various ways or directly connected to server 104. For example, as shown in FIG. 1, clients 102 are connected directly to wide-area network 100 through direct or dial-up telephone or other network transmission line. Alternatively, clients 102 may be connected to wide-area network 100 through a conventional modem pool (not shown).

Using one of a variety of network connection devices, server computer 104 can also communicate directly with a client 102. In a particular implementation of this network configuration, a server computer 104 may operate as a web server if the World Wide Web (Web) portion of the Internet is used as wide-area network 100. Using the Hyper Text Transfer Protocol (HTTP) and the Hyper Text Markup Language (HTML) across a network, web server 104 may communicate across the Web with client 102. In this configuration, client 102 uses a client application program known as a web browser, such as the Netscape Navigator™ browser, published by America Online™, the Internet Explorer™ browser, published by Microsoft Corporation of Redmond, Wash., the user interface of America Online™, or the web browser or HTML translator of any other supplier. Using such conventional browsers and the Web, client 102 may access graphical and textual data or video, audio, or tactile data provided by server 104. Conventional means exist by which client 102 may supply information to web server 104 through the network 100 and the web server 104 may return processed data to client 102.

Server 104 is further connected to storage device 106. Storage device 106 may be any suitable storage medium, for example read only memory (ROM), random access memory (RAM), EPROMs, EEPROMs, magneto-optical discs, or any other type of medium suitable for storing electronic data.

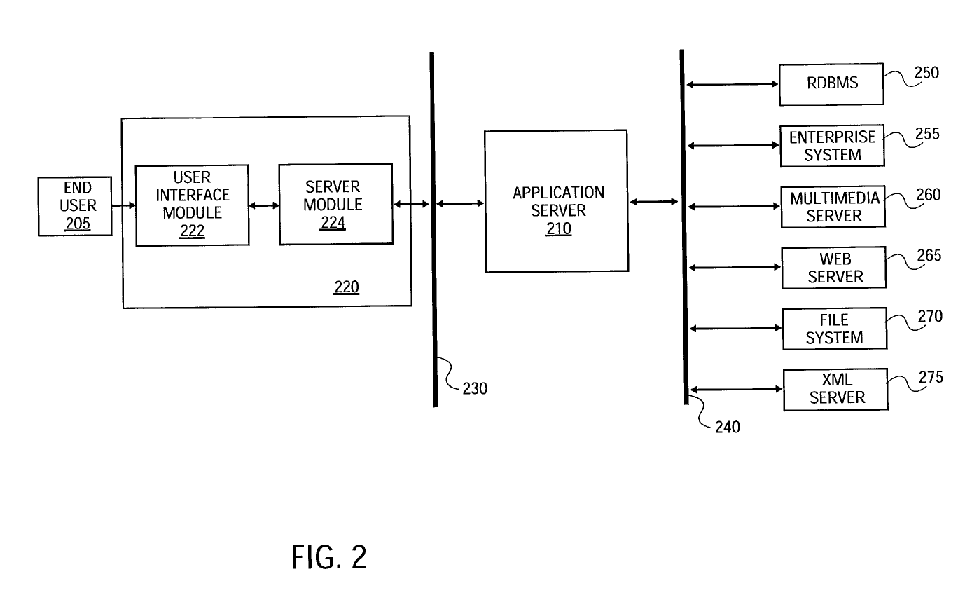

FIG. 2 is a block diagram of one embodiment for the network including a system to transfer an application to a destination server module in a predetermined storage format. As illustrated in FIG. 2, in one embodiment, application server 210 is connected to one or more clients 220 via bus 230, of which only one client 220 is shown. Alternatively, server 210 may be connected to clients 220 via WAN 100. A client 220 further includes a user interface module 222 coupled to a server module 224.

End users, for example end user 205, interact with the client 220 via user interface module 222. In one embodiment, end user 205 interacts with the user interface module 222 within client 220 through a browser (not shown) and WAN 100. Alternatively, end user 205 may interact with user interface module 222 directly or through any connection of a number of known types of connections.

In one embodiment, server 210 is also connected to several data sources via bus 240. Alternatively, server 210 may be connected to the data sources via WAN 100. The data sources may include for example a relational database module (RDBMS) 250, an enterprise system 255, a multimedia server 260, a web server 265, a file system 270, and/or an XML server 275. Alternatively, server 210 may be connected to any of a variety of additional data sources. In one embodiment, the data sources reside in storage device 106. Alternatively, the data sources may reside on disparate storage mediums.

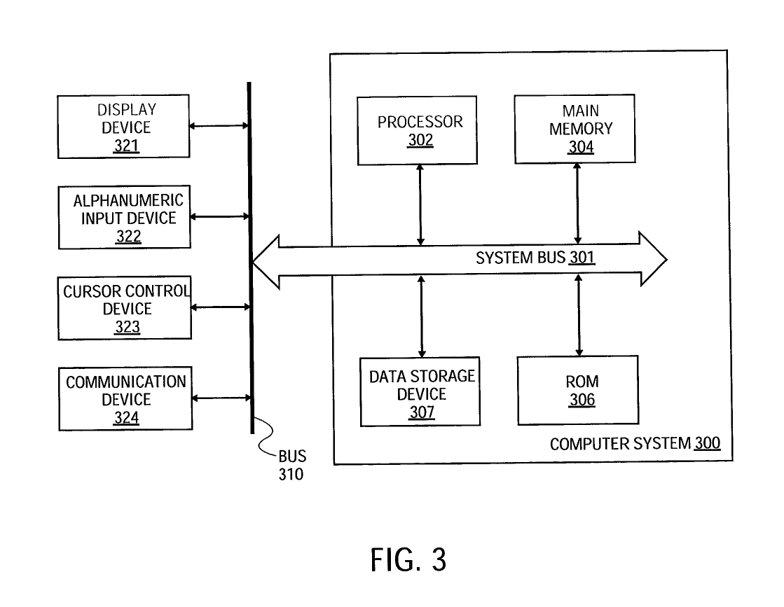

Having briefly described one embodiment of the network environment in which the present invention operates, FIG. 3 shows an exemplary block diagram of a conventional computer system 300 illustrating an exemplary client 102 or server 104 computer system in which the features of the present invention may be implemented.

Computer system 300 includes a system bus 301, or other communications module similar to the system bus, for communicating information, and a processing module, such as processor 302, coupled to bus 301 for processing information. Computer system 300 further includes a main memory 304, such as a random access memory (RAM) or other dynamic storage device, coupled to bus 301, for storing information and instructions to be executed by processor 302. Main memory 304 may also be used for storing temporary variables or other intermediate information during execution of instructions by processor 302.

Computer system 300 also comprises a read only memory (ROM) 306, and/or other similar static storage device, coupled to bus 301, for storing static information and instructions for processor 302.

In one embodiment, an optional data storage device 307, such as a magnetic disk or optical disk, and its corresponding drive, may also be coupled to computer system 300 for storing information and instructions. System bus 301 is coupled to an external bus 310, which connects computer system 300 to other devices. In one embodiment, computer system 300 can be coupled via bus 310 to a display device 321, such as a cathode ray tube (CRT) or a liquid crystal display (LCD), for displaying information to a computer user. For example, graphical or textual information may be presented to the user on display device 321. Typically, an alphanumeric input device 322, such as a keyboard including alphanumeric and other keys, is coupled to bus 310 for communicating information and/or command selections to processor 302. Another type of user input device is cursor control device 323, such as a conventional mouse, touch mouse, trackball, or other type of cursor direction keys, for communicating direction information and command selection to processor 302 and for controlling cursor movement on display 321. In one embodiment, computer system 300 may optionally include video, camera, speakers, sound card, and many other similar conventional options.

Alternatively, the client 102 can be implemented as a network computer or thin client device, such as the WebTV Networks™ Internet terminal or the Oracle™ NC. Client 102 may also be a laptop or palm-top computing device, such as the Palm Pilot™. Such a network computer or thin client device does not necessarily include all of the devices and features of the above-described exemplary computer system. However, the functionality of the present invention may nevertheless be implemented with such devices.

A communication device 324 is also coupled to bus 310 for accessing remote computers or servers, such as server 104, or other servers via the Internet, for example. The communication device 324 may include a modem, a network interface card, or other well-known interface devices, such as those used for interfacing with Ethernet, Token-ring, or other types of networks. In any event, in this manner, the computer system 300 may be coupled to a number of servers 104 via a conventional network infrastructure such as the infrastructure illustrated in FIG. 1 and described above.

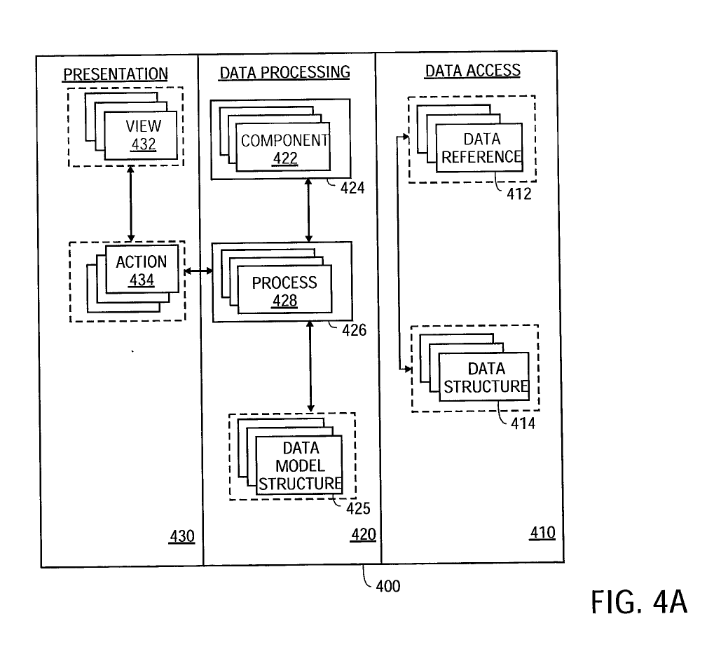

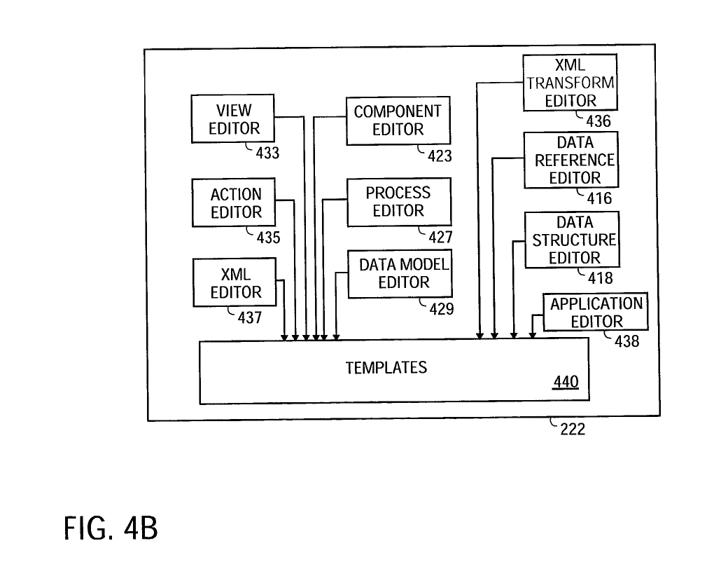

FIG. 4A is a block diagram of an application architecture. As illustrated in FIG. 4A, in one embodiment, application 400 includes a data access layer 410 configured to access and extract data from one or more data sources 250-275, shown in FIG. 2, a data processing layer 420 coupled to the data access layer 410 and configured to process and manipulate data, and a presentation layer 430 coupled to the data processing layer 420 and configured to interact with the processed data and to present one or more views of the processed data to an end user 205.

The data access layer 410 includes multiple data reference structures 412 which define ways to locate and connect to data within the data sources 250-275, and multiple data structures 414, which are typically based on the data reference structures 412.

In one embodiment, each data reference structure 412 is an object that specifies the source connection information to data. For example, one data reference structure 412 may be defined to access a relational database located locally or on a remote server, such as RDBMS 250 shown in FIG. 2. Alternatively, other data reference structures 412 may be a flat file, a web file, or an XML document, designed to connect to file system 270, web server 265, or XML server 275, respectively. A user 205 may define one or more data reference structures 412 using a data reference editor residing within the user interface module 222.

In one embodiment, each data structure 414 is an object, which refers to one or more data reference structures 412 and which includes metadata that defines the data to be accessed, specifies a set of operations to be performed on the data, and defines logic to be applied when data is retrieved from the accessed data source. Alternatively, some data structures 414, labeled abstract data structures, may be created without a reference to a data reference structure. In one embodiment, the set of operations specified are SQL operations and include operations to query, insert, update, and delete data.

A user 205 may create data structures 414 using a data structure editor residing within the user interface module 222. Once created, each data structure 414 is reusable and may be used by different users 205 to extract data from the data sources 250-275.

Referring back to FIG. 4A, data processing layer 420 includes multiple components 422 stored in one or more libraries 424. Each component 422 is a reusable logic object that performs a specific task within the data processing layer 420, for example iterations, control flow, counter, and SQL operations, such as query, insert, update, delete. Each component 422 may be stored and accessed through libraries 424, which are dynamically recompiled and reloaded at runtime. A user 205 may create components 422 using a component editor residing within the user interface module 222.

Data processing layer 420 further includes one or more processes 428 stored in a processing module 426. Each process 428 uses predetermined sets of components 422, linked together to process data retrieved from data sources 250-275.

Each process 428 is defined by the corresponding set of components 422, and by a data model structure 425, which defines and stores pieces of data read and written by the process 428. A user 205 may define processes 428 using a process editor residing within the user interface module 222. Processes 428 will be described in further detail below.

In one embodiment, data model structure 425 is visible only to its corresponding process 428 and includes properties that define each data item retrieved from data sources 250-275, for example Input, Output, In-Out, or Static, optionality, and whether each data item is secure or not. Alternatively, each data model structure 425 may be transparent and, as a result, accessible to all processes 428 defined within the processing module 426. In one embodiment, data model structures 425 may be nested and may form a nested structure.

Referring back to FIG. 4A, presentation layer 430 includes multiple views 432, which allow users 205 to view processed data. In one embodiment, views 432 are Java Server Page (JSP) views. Each JSP view 432 is a dynamic page, for example an HTML page, which supports event-based input mechanisms and contains special tags interpretable by the server 210. Alternatively, views 432 may be presented in extensible Markup Language (XML). In one embodiment, each XML view 432 is an XML document accessible to users 205 via Universal Resource Locators (LJRLs).

Each view 432 includes a mechanism for triggering an action 434 and sets of data transmitted from the data model structures 425 and formatted for the type of view, for example in JSP or XML formats. In one embodiment, actions 434 reside within presentation layer 430 and provide a linkage between users 205 and processes 428. Each action 434 is coupled to one or more views 432 that can trigger that action. Also, each action 434 is further coupled to a process 428 triggered by the action and to a set of views 434 that must be activated after the process 428 concludes.

FIG. 4B is a block diagram of one embodiment for a user interface module. As illustrated in FIG. 4B, the user interface module 222 includes a data reference editor 416 to define one or more data reference structures 412 within the data access layer 410 of the application 400 and a data structure editor 418 to create one or more data structures 414 within the data access layer 410.

User interface module 222 further includes a component editor 423 to create sets of components 422 within the data processing layer 420 of the application 400 and a process editor 427 to define and run processes 428 within the data processing layer 420. A data model editor is further provided within the user interface module 222 to define data model structures 425 for processes 428.

User interface module 222 further includes a view editor 433 to create one or more views 432 within the presentation layer 430 of the application 400 and an action editor 435 to define actions 434 within the presentation layer 430. In one embodiment, an XML editor 437 is provided within user interface module 222 to create views 432 presented in XML format and an XML transform editor 436 is further provided to convert documents created in a source format from a source Document Type Definition (DTD), for example XML, to a target DTD, for example HTML, and to present the document to users in the target format defined by the target DTD.

User interface module 222 further includes an application editor 438 to enable user 205 to create visually an application and to manipulate application components of the application in an application layout displayed for the user 205, as described in further detail below.

In one embodiment, user interface module 222 further includes templates 440. The editors within user interface module 222 use templates 440 to create or define corresponding structures for the application 400.

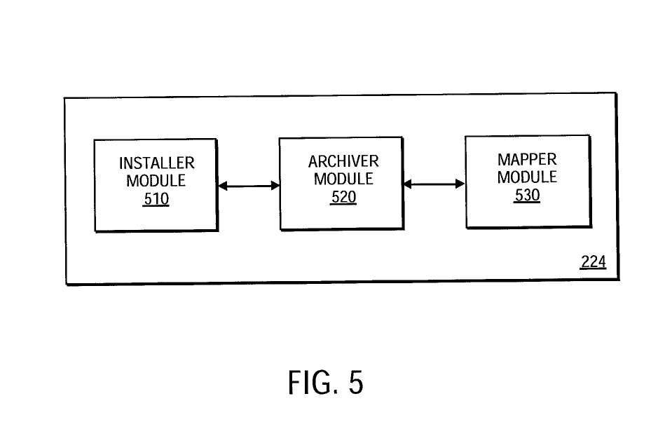

FIG. 5 is a block diagram of one embodiment for a server module 224. As illustrated in FIG. 5, in one embodiment, server module 224 includes an installer module 510, which is a programmable hardware and/or software module to install a configuration of the client 220 and to configure a property file, as described in further detail below.

The server module 224 further includes an archiver module 520 coupled to the installer module 510. The archiver module is a programmable hardware and/or software module to store an application 400 in a predetermined storage format, such as, for example, a compressed zip file format, to transmit the application to a destination server module 224 in the predetermined storage format, and to perform other operations associated with the storing of the application, as described in further detail below.

The server module 224 further includes a mapper module 530 coupled to the installer module 510 and to the archiver module 520. The mapper module 530 is a programmable hardware and/or software module to install an application 400 received from a source server module 224 and to perform other operations associated with the installation, as described in further detail below.

During the installation of the configuration information for the server module 224, a property file is configured to store key/value pairs embodied in property names and associated path names. Each property name stored within the property file is assigned a corresponding associated path name within the configuration. In one embodiment, the property file may be accessed and its contents may be altered by the user 205 via the user interface module 222. Alternatively, the user 205 may use the property file in its default configuration.

The property file may be represented, for example, as a table containing pairs of property names and associated path names, as shown in Table 1, where specific values for the property names and the corresponding path names are only examples and should not be construed as limiting to the particular embodiment:

TABLE 1
PROPERTY FILE

| Property Name | Path Name |
|---|---|
| EJB STORAGE | F:\altoweb\internal |
| APPLICATION ROOT | F:\altoweb\applications\root |

In one embodiment, as each component of the application 400, such as, for example, an action 434, a view 432, or a process 428, is created, the installer module 510 accesses the property file to determine the file storage location of the component being created. The installer module 510 retrieves a specific path name, which defines the file storage location, and further directs the particular application component being created to the predetermined file storage location based on the retrieved path name.

The operations described below refer to the application 400, but it is to be understood that operations referring to one or more components of the application 400 may be performed in a similar manner. Subsequent to the creation of the application 400, if the need arises to transfer the application 400, or a component of the application 400, from a source server module to a destination server module, the archiver module 520 retrieves the application 400 from the file storage location defined by the selected path name and further retrieves a path name associated with each application component of the application 400.

The archiver module 520 further accesses the property file to retrieve a property name associated with the path name for each application component of the application 400 and applies the property name to the corresponding application component. Subsequently, the archiver module 520 stores the application 400 and the property names associated with all the application components of the application 400 in a predetermined storage format, such as the compressed zip file format, and transmits the compressed file to the destination server module 224.

For example, if the application 400 is stored at the storage location F:\altoweb\applications\myApp, the archiver module 520 retrieves the APPLICATION ROOT property name corresponding to the F:\altoweb\applications path name from the property file shown in Table 1, and appends the property name to the application 400. Finally, the APPLICATION ROOT\myApp is stored in compressed zip file format and is transmitted to the destination server module 224.

If a component of the application 400, for example an action “action1” 434, is stored at F:\altoweb\internal\action1, the archiver module 520 retrieves the EJB STORAGE property name corresponding to the F:\altoweb\internal path name. The EJB STORAGE\action1 component is subsequently stored in compressed zip file format and is transmitted to the destination server module 224.

In one embodiment, the destination server module 224 includes a destination property file containing property names and corresponding destination path names. For example, the destination property file may be represented, for example, as a table containing the pairs of property names and associated destination path names, as shown in Table 2, where specific values for the property names and the corresponding destination path names are only examples and should not be construed as limiting to the particular embodiment:

TABLE 2
DESTINATION PROPERTY FILE

| Property Name | Path Name |
|---|---|
| EJB STORAGE | F:\users\me\altoweb\private |
| APPLICATION ROOT | F:\users\me\altoweb\applications\root |

The mapper module 530 of the destination server module 224 receives the application 400 and the associated property names in the predetermined format and retrieves each property name. The mapper module 530 then accesses the destination property file to retrieve a destination path name corresponding to each retrieved property name and applies the destination path name to the corresponding application component of the application 400. Subsequently, the mapper module 530 installs each respective application component to a destination file storage location defined by the corresponding destination path name.

For example, if the mapper module 530 receives the APPLICATION ROOT\myApp application, it retrieves the APPLICATION ROOT property name. Then, the mapper module 530 accesses the destination property file shown in Table 2 to retrieve the destination path name F:\users\me\altoweb\applications\root and installs the application F:\users\me\altoweb\applications\myApp at the destination file storage location defined by the destination path name.

Similarly, if the mapper module 530 receives the EJB STORAGE\action1 component, it retrieves the EJB STORAGE property name. Then, the mapper module 530 accesses the destination property file shown in Table 2 to retrieve the destination path name F:\users\me\altoweb\private corresponding to the EJB STORAGE property name and installs the component F:\users\me\altoweb\private\action1 at the destination file storage location defined by the destination path name.

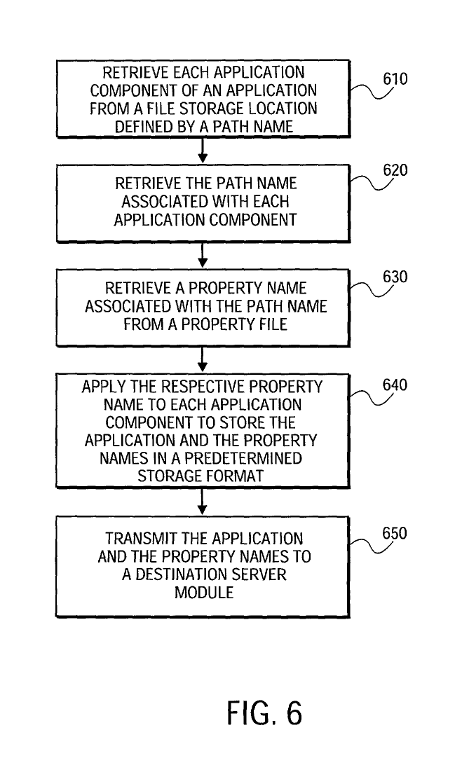

FIG. 6 is a flow diagram of one embodiment for a method to transfer an application to a destination server module in a predetermined storage format from the perspective of a source server module. As illustrated in FIG. 6, at processing block 610, each application component of an application is retrieved from a file storage location defined by a path name.

At processing block 620, the path name associated with each application component is retrieved. At processing block 630, a corresponding property name associated with the path name is retrieved from a property file.

At processing block 640, the respective property name is applied to each application component in order to store the application and the property names in a predetermined storage format. Finally, at processing block 650, the application and the property names are transmitted to a destination server module in the predetermined storage format.

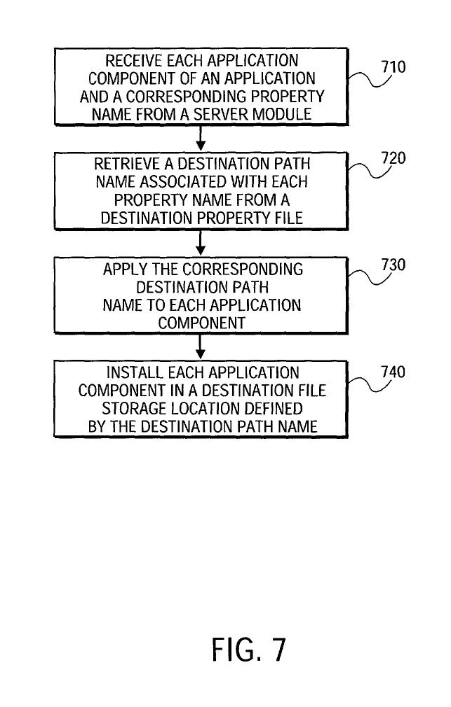

FIG. 7 is flow diagram of the embodiment for the method from the perspective of the destination server module. As illustrated in FIG. 7, at processing block 710, each application component and the corresponding property name are received in the destination server module from a source server module.

At processing block 720, a destination path name associated with each received property name is retrieved from a destination property file. At processing block 730, the corresponding destination path name is appended to each application component. Finally, at processing block 740, each application component of the application is installed in a destination storage location defined by the corresponding destination path name.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method to transfer an application to a destination server module in a predetermined storage format, said method comprising:
retrieving a property name associated with a path name for each application component of said application from a property file containing a plurality of property names including said property name and a plurality of path names including said corresponding path name; and
applying said property name to said each application component to store said application and said property name associated to said each application component in said predetermined storage format.

2. The method according to claim 1, further comprising:
retrieving said each application component of said application from a file storage location defined by said path name within a server module; and
retrieving said path name associated with said each application component.

3. The method according to claim 2, further comprising:
configuring said property file in said server module; and
assigning each property name of said plurality of property names to said corresponding path name of said plurality of path names.

4. The method according to claim 3, wherein said property file is configured as a table containing pairs of said each property name and said corresponding path name.

5. The method according to claim 1, further comprising:
transmitting said application and said property name associated with said each application component to said destination server module in said predetermined storage format.

6. The method according to claim 1, wherein said predetermined storage format is a compressed zip file format.

7. The method according to claim 5, wherein said destination server module further retrieves a destination path name associated with said property name of said each application component from a destination property file containing a plurality of destination path names including said destination path name and said plurality of property names including said property name, and applies said destination path name to said each application component of said application in order to install said application.

8. A method to transfer an application from a server module in a predetermined storage format, said method comprising:
retrieving a destination path name associated with a property name for each application component of said application from a destination property file containing a plurality of property names including said property name and a plurality of destination path names including said corresponding destination path name; and
applying said destination path name to said each application component in order to install said application.

9. The method according to claim 8, further comprising:
installing said each application component to a destination file storage location defined by said destination path name.

10. The method according to claim 8, further comprising:
receiving said each application component and said property name from said server module in said predetermined storage format.

11. The method according to claim 8, further comprising:
configuring said destination property file; and
assigning each property name of said plurality of property names to said corresponding destination path name of said plurality of destination path names.

12. The method according to claim 11, wherein said destination property file is configured as a table containing pairs of said each property name and said corresponding destination path name.

13. The method according to claim 8, wherein said predetermined storage format is a compressed zip file format.

14. The method according to claim 8, wherein said server module further retrieves said property name associated with a path name for said each application component of said application from a property file containing said plurality of property names including said property name and a plurality of path names including said corresponding path name; and applies said property name to said each application component to store said application and said property name associated with said each application component in said predetermined storage format.

15. A system to transfer an application to a destination server module in a predetermined storage format, said system comprising:
means for retrieving a property name associated with a path name for each application component of said application from a property file containing a plurality of property names including said property name and a plurality of path names including said corresponding path name; and
means for applying said property name to said each application component to store said application and said property name associated to said each application component in said predetermined storage format.

16. The system according to claim 15, further comprising:
means for retrieving said each application component of said application from a file storage location defined by said path name within a server module; and
means for retrieving said path name associated with said each application component.

17. The system according to claim 16, further comprising:
means for configuring said property file in said server module; and
means for assigning each property name of said plurality of property names to said corresponding path name of said plurality of path names.

18. The system according to claim 17, wherein said property file is configured as a table containing pairs of said each property name and said corresponding path name.

19. The system according to claim 15, further comprising:
means for transmitting said application and said property name associated with said each application component to said destination server module in said predetermined storage format.

20. The system according to claim 15, wherein said predetermined storage format is a compressed zip file format.

21. The system according to claim 19, wherein said destination server module further retrieves a destination path name associated with said property name of said each application component from a destination property file containing a plurality of destination path names including said destination path name and said plurality of property names including said property name, and applies said destination path name to said each application component in order to install said application.

22. A system to transfer an application from a server module in a predetermined storage format, said system comprising:
means for retrieving a destination path name associated with a property name for each application component of said application from a destination property file containing a plurality of property names including said property name and a plurality of destination path names including said corresponding destination path name; and
means for applying said destination path name to said each application component in order to install said application.

23. The system according to claim 22, further comprising:
means for installing said each application component to a destination file storage location defined by said destination path name.

24. The method according to claim 22, further comprising:
means for receiving said each application component and said property name from said server module in said predetermined storage format.

25. The system according to claim 22, further comprising:
means for configuring said destination property file; and
means for assigning each property name of said plurality of property names to said corresponding destination path name of said plurality of destination path names.

26. The system according to claim 25, wherein said destination property file is configured as a table containing pairs of said each property name and said corresponding destination path name.

27. The system according to claim 22, wherein said predetermined storage format is a compressed zip file format.

28. The system according to claim 22, wherein said server module further retrieves said property name associated with a path name for said each application component of said application from a property file containing said plurality of property names including said property name and a plurality of path names including said corresponding path name, and applies said property name to said each application component to store said application and said property name associated with said each application component in said predetermined storage format.

29. A computer readable medium containing executable instructions, which, when executed in a processing system, cause said processing system to perform a method comprising:
retrieving a property name associated with a path name for each application component of said application from a property file containing a plurality of property names including said property name and a plurality of path names including said corresponding path name; and
applying said property name to said each application component to store said application and said property name associated to said each application component in said predetermined storage format.

30. The computer readable medium according to claim 29, wherein said method further comprises:
retrieving said each application component of said application from a file storage location defined by said path name within a server module; and
retrieving said path name associated with said each application component.

31. The computer readable medium according to claim 30, wherein said method further comprises:
configuring said property file in said server module; and
assigning each property name of said plurality of property names to said corresponding path name of said plurality of path names.

32. The computer readable medium according to claim 31, wherein said property file is configured as a table containing pairs of said each property name and said corresponding path name.

33. The computer readable medium according to claim 29, wherein said method further comprises:
transmitting said application and said property name associated with said each application component to said destination server module in said predetermined storage format.

34. The computer readable medium according to claim 29, wherein said predetermined storage format is a compressed zip file format.

35. The computer readable medium according to claim 33, wherein said destination server module further retrieves a destination path name associated with said property name of said each application component from a destination property file containing a plurality of destination path names including said destination path name and said plurality of property names including said property name, and applies said destination path name to said each application component of said application in order to install said application.

36. A computer readable medium containing executable instructions, which, when executed in a processing system, cause said processing system to perform a method comprising:
retrieving a destination path name associated with a property name for each application component of said application from a destination property file containing a plurality of property names including said property name and a plurality of destination path names including said corresponding destination path name; and
applying said destination path name to said each application component in order to install said application.

37. The computer readable medium according to claim 36, wherein said method further comprises:
installing said each application component to a destination file storage location defined by said destination path name.

38. The computer readable medium according to claim 36, wherein said method further comprises:
receiving said each application component and said property name from said server module in said predetermined storage format.

39. The computer readable medium according to claim 36, wherein said method further comprises:
configuring said destination property file; and
assigning each property name of said plurality of property names to said corresponding destination path name of said plurality of destination path names.

40. The computer readable medium according to claim 39, wherein said destination property file is configured as a table containing pairs of said each property name and said corresponding destination path name.

41. The computer readable medium according to claim 36, wherein said predetermined storage format is a compressed zip file format.

42. The computer readable medium according to claim 36, wherein said server module further retrieves said property name associated with a path name for said each application component of said application from a property file containing said plurality of property names including said property name and a plurality of path names including said corresponding path name; and applies said property name to said each application component to store said application and said property name associated with said each application component in said predetermined storage format.

43. A system to transfer an application to a destination server module in a predetermined storage format, said system comprising:
an installer module; and
an archiver module coupled to said installer module to retrieve a property name associated with a path name for each application component of said application from a property file containing a plurality of property names including said property name and a plurality of path names including said corresponding path name, and to apply said property name to said each application component to store said application and said property name associated with said each application component in said predetermined storage format.

44. The system according to claim 43, wherein said archiver module further retrieves said each application component from a file storage location defined by said path name, and retrieves said path name associated with said each application component.

45. The system according to claim 44, wherein said installer module further configures said property file and assigns each property name of said plurality of property names to said corresponding path name of said plurality of path names.

46. The system according to claim 45, wherein said property file is configured as a table containing pairs of said each property name and said corresponding path name.

47. The system according to claim 43, wherein said archiver module further transmits said application and said property name associated with said each application component to said destination server module in said predetermined storage format.

48. The system according to claim 43, wherein said predetermined storage format is a compressed zip file format.

49. The system according to claim 47, wherein said destination server module further retrieves a destination path name associated with said property name of said each application component from a destination property file containing a plurality of destination path names including said destination path name and said plurality of property names including said property name, and applies said destination path name to said each application component of said application in order to install said application.

50. A system to transfer an application from a server module in a predetermined storage format, said system comprising:
an installer module; and
a mapper module coupled to said installer module to retrieve a destination path name associated with a property name for each application component of said application from a destination property file containing a plurality of property names including said property name and a plurality of destination path names including said corresponding destination path name, and to apply said destination path name to said each application component in order to install said application.

51. The system according to claim 50, wherein said mapper module further installs said each application component of said application to a destination file storage location defined by said destination path name.

52. The system according to claim 50, wherein said mapper module further receives said each application component and said property name from said server module in said predetermined storage format.

53. The system according to claim 50, wherein said installer module further configures said destination property file, and assigns each property name of said plurality of property names to said corresponding destination path name of said plurality of destination path names.

54. The system according to claim 53, wherein said destination property file is configured as a table containing pairs of said each property name and said corresponding destination path name.

55. The system according to claim 50, wherein said predetermined storage format is a compressed zip file format.

56. The system according to claim 50, wherein said server module further retrieves said property name associated with a path name for said each application component of said application from a property file containing said plurality of property names including said property name and a plurality of path names including said corresponding path name; and applies said property name to said each application component to store said application and said property name associated with said each application component in said predetermined storage format.
